(19) United States
(12) Patent Application Publication
(10) Pub. No.: US 2025/0178160 A1
(43) Pub. Date: Jun. 5, 2025

(54) Rotatable C Clamp

(71) Applicant: Carinne White, South Jordan, UT (US)

(72) Inventor: Carinne White, South Jordan, UT (US)

(21) Appl. No.: 18/526,140

(22) Filed: Dec. 1, 2023

(51) Int. Cl. B25B 5/06; B25B 5/16

(52) U.S. Cl. CPC B25B 5/067; B25B 5/16

(57) ABSTRACT

The present invention relates to a rotatable C-clamp, offering improved versatility in clamping objects on multiple planes. Conventional clamps are often rigid, limiting their orientation to a fixed position. This invention addresses the need for a clamp with rotational capability, allowing it to engage objects on various planes. The clamp features a C-shaped structure with a body and opposing arms. Each arm is designed to receive an object, and the clamp is made of rigid material such as metal. The key innovation involves a rotatable connection between the clamp and its base, facilitating engagement with objects in different orientations. A threaded bolt with a knob is employed to secure the clamp, providing users with control over the clamping force. The invention finds applications in carpentry, construction, and other crafts where flexible clamping is advantageous.

### FIELD OF INVENTION

The present invention relates to the field of fasteners, and more particularly to an improved clamping device with a C-shaped structure.

### BACKGROUND OF INVENTION

Clamps, in general, are used to fasten one object to another. They come in a number of different shapes and sized to fit numerous applications. In current art, clamps often have one or more moveable members, which can be turned by a threaded rod to move the members along an axis. As the members move towards one-another they contact one or more objects, holding them together by increasing the force of friction between the two objects. Clamps are often used in carpentry, construction and other crafts to keep object from moving without the user having to hold the object in place.

C-clamps can be mounted to an object allowing for the object to be releasably engaged with another. In an example, a c-clamp is positioned at the bottom of a handwringer, allowing for the hand wringed to then be releasably engaged with a bucket. This allows for the handwringer to be positioned on top of the wall of the bucket at the perimeter.

The above-mentioned example utilized a clamp that is in a fixed position at the bottom of the handwringer. The clamp is positioned to receive the perimeter of the bucket; however, the clamp is unable to receive objects that are not receivable in the same plane. Walls of the bucket extend in a vertical plane, requiring that the open end of the C-clamp be positioned in the vertical plan as well. If a user wished to attach the handwringer to a table, the open end of the C-clamp would need to lie in the horizontal plane.

Clamps are inherently rigid in design, allowing them to maintain their orientation, such that the one or more objects held by the clamp do not move. For many applications, this is a desired trait, however in the above example of the handwringer, it would be useful to have a clamp that can articulate about a rotational axis, allowing the clamp to attach to objects on more than one plane.

Based on the foregoing, there is a need in the art for a clamp which is able to rotate at an anchor point, allowing the clamp to releasably engage objects on multiple planes.

### SUMMARY OF THE INVENTION

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is the perspective top view of the C Clamp, according to an embodiment of the present invention;

FIG. 2 is the perspective top view of the C Clamp, according to an embodiment of the present invention.

FIG. 3 is the perspective side view displaying the detached clamps of the C Clamp, according to an embodiment of the present invention.

FIG. 4 is the perspective side view showing the attached clamps of the C Clamp, according to an embodiment of the present invention.

FIG. 5 is the front view of a coupled C clamp, according to an embodiment of the present invention.

FIG. 6 is the perspective view of the C Clamp, according to an embodiment of the present invention.

### DETAILED DESCRIPTION OF PREFERRED EMBODIMENTS

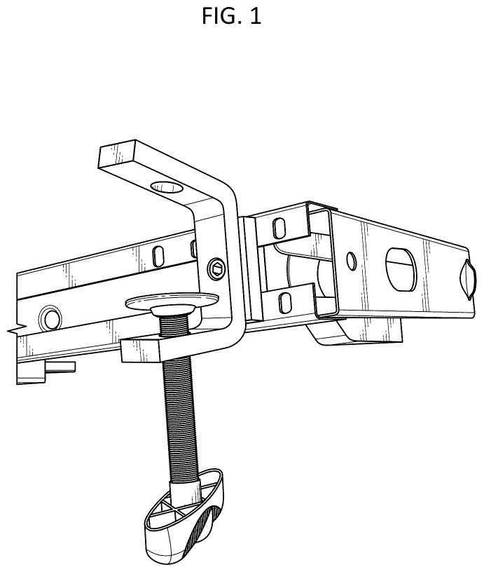

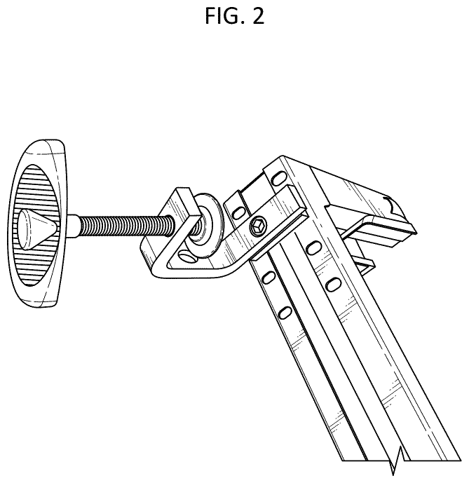

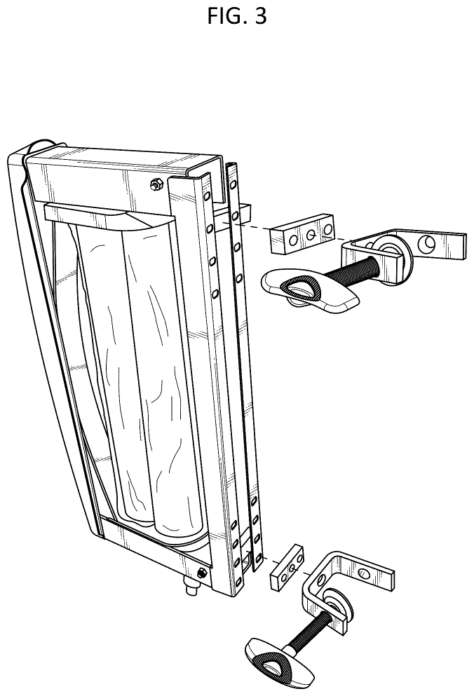

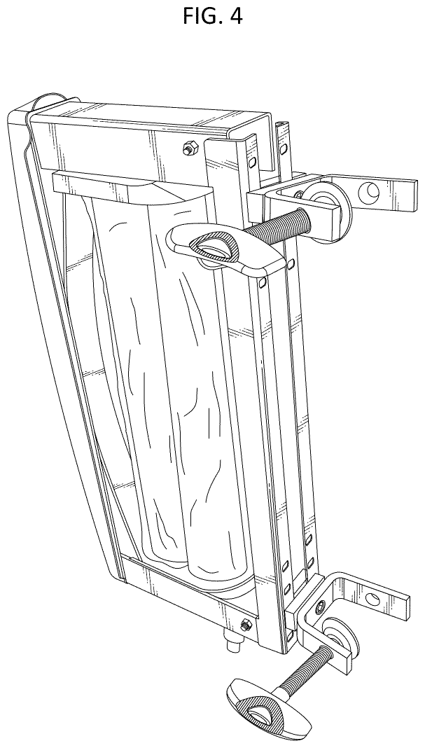

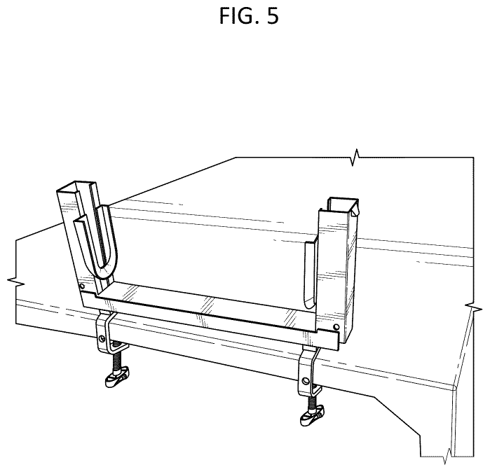

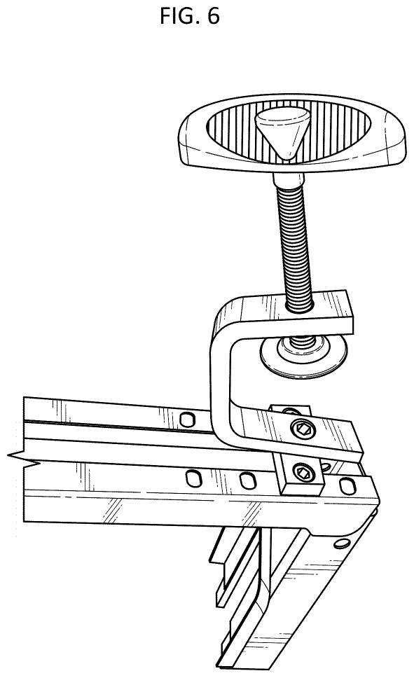

Preferred embodiments of the present invention and their advantages may be understood by referring to FIGS. 1-6, wherein like reference numerals refer to like elements.

The invention disclosed herein refers to a clamp that may be releasably engaged with an object. The clamp is generally C-shaped with a body attached or integrally molded to two opposing arms that protrude from the base member. Each arm is positioned to receive an object between one another. The clamp is made of rigid material such as metal, for example, steel.

Each boss comprises a circumferential through-hole, adapted to receive a threaded bolt, screw, or other fastening component. The body, and each arm may be releasably engaged with a base. The base is mounted to an object that the user wishes to mount to an additional object such that the two objects are in a fixed position in reference to one another.

In an embodiment, the base is mountable to the body, or an arm of the device. The threaded bolt must be threadingly engaged with either arm such the bolt can extend through the circumferential through holes to contact the opposing arm or an object disposed between the opposing arms.

In an embodiment, the threaded bolt extends through a circumferential through-hole. The threaded bolt comprises a threaded pin, having two ends. A first end comprises a knob, allowing the user to turn the threaded bolt, thus extending or retracting the bolt through the circumferential through-hole. The knob extends radially from the axis of the threaded bolt giving the user additional leverage to turn the bolt and clamp an object. The knob gives the user better grip to tighten the bolt to frictionally engage an object between the arms of the C-clamp. A second end of the threaded bolt comprises a head having a circumference greater than the circumference of the threaded bolt. The head may articulate about a fulcrum on the threaded bolt or the head may be rigidly mounted to the end of the threaded bolt. The function of the head is to provide a larger contact point between the threaded bolt and the object, such that the force of the threaded bolt pressing the object between the bolt and the arm does not damage the object. Further, the head gives a larger surface area to increase the friction between the head and one of the arms of the clamp.

In use, the base of the C-clamp must first be mounted to an object, for example, the bottom base of a handwringer. The base is bolted or in engaged with the bottom of the handwringer such that is it in a fixed position. Next, the user pivotally mounts either the body or an arm of the C-clamp. Pivotally mounting the base of the C-clamp allows the clamp to engage with an object that has a vertically extending mountable surface, such as the sidewalls of a bucket. Contrarily, pivotally mounting an arm of the clamp to the base allows for the clamp to releasably engage an object that has a horizontal attachable surface, such the edge of a table. Pivotal mountability between the clamp and base also permits the engagement with a object in which the edge extends at any angle in a 360° plane. To utilize this feature, the user may choose to mount the handwringer at the corner of a rectangular bucket. Such that a first C-clamp is engaged with a side of the bucket, and a second C-clamp is engaged with an adjacent side of the bucket.

In an embodiment, the C-clamp is pivotally mounted to the base by a bolt. Preferentially, the bolt is threaded at an end in order to threadingly engage the C-clamp to the base. The middle of the bolt is unthreaded allowing for the clamp to pivot. Other methods of attaching to object while retaining pivotability may be used as known in the art.

The base comprises three threaded through holes. Two holes are positioned at each end of the base such that the base can be mounted to the handwringer, or other object. A third hole is positioned between the two opposing through holes and threadingly engages the mounting bolt of the C-clamp. Mounting to only one hole allows for the C-clamp to pivot.

In a preferred embodiment, circumferential through-holes of each arm and the body of the C-clamp are uniform, allowing for each of the through-holes to receive either the threaded clamp bolt, or the mounting bolts interchangeably. This feature allows for maximum customization of the device by the user.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

1. A rotatable C-clamp comprising:
a. a C-shaped body with two opposing arms and a base member;
b. a base mountable to an object, said base having multiple threaded through holes;
c. a clamp pivotally mounted to said base, allowing rotation about a fulcrum;
d. each arm and the body of the C-clamp comprising circumferential through-holes;
e. a threaded bolt with a knob, engageable with said through-holes to adjust clamping force;
f. said threaded bolt further comprising a head with a larger circumference to prevent damage to clamped objects;
g. the base being attachable to an object in a fixed position, facilitating rotation of the clamp to engage objects on multiple planes;
h. the clamp being selectively pivotable, enabling engagement with objects having vertical, horizontal, or angled surfaces;
i. the through-holes of each arm and body accommodating interchangeably either the threaded clamp bolt or mounting bolts.

2. The rotatable C-clamp of claim 1, wherein the pivotable connection between the clamp and base is facilitated by a threaded bolt, allowing pivotal movement while maintaining a secure attachment.

3. The rotatable C-clamp of claim 1, wherein the circumferential through-holes of each arm and the body are uniform, providing versatility for users to customize the device.

4. The rotatable C-clamp of claim 1, wherein the knob of the threaded bolt extends radially from the axis, providing additional leverage for users to adjust clamping force.

5. The rotatable C-clamp of claim 1, wherein the base comprises three threaded through holes, with two positioned at each end for mounting to an object and a third positioned between them for threadingly engaging the mounting bolt of the C-clamp.

6. The rotatable C-clamp of claim 1, finding application in carpentry, construction, and crafts where flexible clamping on multiple planes is advantageous.

7. The rotatable C-clamp of claim 1, wherein the clamp is made of rigid material, such as metal, for durability and strength.

8. The rotatable C-clamp of claim 1, wherein the invention provides a solution to the limitations of conventional clamps by allowing rotation at an anchor point, thereby enhancing its ability to engage objects on various planes.
